(19) United States
(12) Patent Application Publication
(10) Pub. No.: US 2013/0043984 A1
(43) Pub. Date: Feb. 21, 2013

(54) Smart Remote

(71) Applicant: Arnold Peter Goetzke, Ann Arbor, MI (US)

(72) Inventor: Arnold Peter Goetzke, Ann Arbor, MI (US)

(21) Appl. No.: 13/213,201

(22) Filed: Aug. 19, 2011

(51) Int. Cl. G08C 19/16

(52) U.S. Cl. 340/12.1

(57) ABSTRACT

A remote control that provides consumers the ability to remotely control the functionality of the buttons by playing an audio file on a Bluetooth device. Each button on the remote has its own specified audio file. The audio files are specifically formatted so that they can be played on a variety of Bluetooth capable devices (Phone, Computer, Tablet) with an audio player. When the appropriate audio file is played, the remote functions as though a button was pressed. This invention eliminates the need for defining special Bluetooth protocols that are required for remote control and the associated hardware/software for such control. Instead, the Smart Remote allows for a standard, universal process for remote control across different operating systems (Windows, Android, Apple, etc. . . . ), without regard to the manufacturer of the controlling device.

### BACKGROUND OF THE INVENTION

Wireless control has been available to consumers for many years in many forms. Infrared technology and RF technology have been the predominant methods used by industry to allow consumers to communicate and control electronic devices wirelessly. With the advent of cellular phones and home computers, WiFi and BlueTooth technology have emerged as new methods of controlling home electronics remotely.

It is estimated that by the end of 2011, 50 percent of Americans will own a Smart Phone. These phones are characterized by the use of software and hardware that takes advantage of the WiFi and BlueTooth capabilities of these devices. More and more, these phones are being used for activities other than just talking.

In order to take advantage of the remote control capabilities of these phones, consumers have the previously mentioned 2 options: WiFi and BlueTooth. WiFi has a higher energy use and is typically more costly to integrate into consumer electronics. However, because of its speed, WiFi is the general choice for networking between computers. BlueTooth has been described as a low cost solution, best for “point to point” communication between electronic devices.

BlueTooth technology has many “profiles” that are used to communicate between devices, such as AVRCP (Audio/Visual Remote Control Profile), A2DP (Advanced Audio Distribution Profile), HSP (Head Set Profile), and HFP (Hands Free Profile) to name a few. Each electronic product that incorporates Bluetooth technology must have the capability designed in to take advantage of each profile, with the appropriate Hardware and Software installed.

Smart Phones and other similar Electronic Devices (Computers, Tablets and such) have predominantly chosen to include the A2DP Audio profile to allow consumers to listen to stereo music. Software internal to the phone allows for it to “Pair” and communicate with another device with the A2DP profile, such as a Stereo Receiver or Wireless Headset.

Similar to the A2DP profile, the Head Set profile is also a funnel of audio data, though providing bidirectional communication through the use of a microphone. This profile is the most predominant profile used in Smart Phones. The use of these two profiles has been so predominant that it is also considered necessary to have the A2DP and Head Set profile for a Smart Phone to be considered Smart.

The A2DP profile, as well as the Head Set profile, is essentially a channel for audio data, receiving it from the Broadcasting BlueTooth device and sending it to a Paired Receiver. It does not require access to any advanced vendor-dependent extensions that can be found in other BlueTooth profiles, such as the AVRCP, nor does it allow for “control” of connected devices.

The remote control profile AVRCP has been incorporated in Smart Phones, but not as predominantly as the audio profiles as mentioned above. This profile allows data to be shared between two BlueTooth devices, with one controlling the other (generally the Phone controlling a Device). The AVRCP profile requires specific software programs that are developed, defining the communication and how data is shared. The Controlled device must be similarly programmed so that it can understand the data and execute commands accordingly.

One of the main drawbacks of the AVRCP profile is that it requires unique software for every Controlling device and its operating software (i.e. Apple, Android, Windows, etc.). This has limited the implementation of consumer products incorporating remote control capabilities utilizing the BlueTooth technology. For example, Apple has a very limited and special procedure and application process to access the Remote Control BlueTooth “stack”, or data pockets that allow for data sharing between paired BlueTooth products.

So, unlike IR and RF Remote Control technologies, BlueTooth has seen a very limited use in consumer products for Control features despite 1) The low cost and power use of the technology; 2) The robustness and security of the technology; and 3) By the end of 2011, 1 in 2 Americans are estimated to be the owners of Smart Phones that contain the technology.

In light of the limited implementation of the use of BlueTooth technology to control devices, there is need for new and innovative products that utilize the available BlueTooth profiles that are common in Smart Phones in a unique and ground breaking manner; A new product that takes advantage of the BlueTooth technological capabilities so that consumers can wirelessly control products in a manner not currently possible.

### BRIEF SUMMARY OF THE INVENTION

This invention, the Smart Remote, is a new and innovative product that allows consumers to remotely control the functionality of buttons on a remote control with their Smart Phone or similar product. The invention eliminates the need to access the “data stack” of various BlueTooth profiles that manage remote control functionality.

The essence of the functionality of the Smart Remote is as follows: Specifically formatted audio files are generated and transmitted to the Smart Remote over a Bluetooth audio connection. The Bluetooth module inside of the remote then sends the appropriate signal to an integrated circuit inside of the remote.

In some embodiments, the integrated circuit may control output to an Infra Red Light Emitting Diode, remotely controlling the function of a TV. Thus, when the matching button on the Smartphone is pressed, the appropriate audio file is played, the integrated circuit is signaled by the Bluetooth module, and the Smart Remote functions as if someone has manually pressed a button.

As an example, a 5 ms duration of 15 khz sound is defined to be a trigger to activate the Power button on a remote. When the invention receives this audio stream from the paired Bluetooth device (i.e. Phone), the Bluetooth control module sends an electrical signal to an integrated circuit inside of the Smart Remote. This signal and input received by the integrated circuit is identical to that sent when the Power button is pressed manually on the remote. Thus, the Smart Remote allows for control by a Bluetooth enabled Smart Phone or similarly capable device.

This process is identical for every button on the remote, each having a unique audio file. For example, a Volume Up Button could have a 10 ms blast of 15 khz sound associated with it. When the Smart Remote receives this stream of audio, the Bluetooth module sends a signal to the integrated circuit, identical to that of the signal received when the Volume Up Button has been pressed. Thus, the every button on the Smart Remote can be controlled by a Bluetooth enabled Smart Phone or similarly capable device.

Although the invention is presented in its simplest form—an IR Remote controlling a TV—the number of buttons and device the Smart Remote controls is limited only by the practical size of a Remote Control and the number of buttons on it. For example, an embodiment could be a complex, 100 button Smart Remote that controls numerous electronic devices within a home theater system. Or, another example of an embodiment could be a simple 1 button Smart Remote that toggles the power of an electronic device.

In summary, the Smart Remote invention provides a unique and innovative method and technology that allows for consumers to remotely control electronics in a manner not currently available. By using the audio profiles of a Bluetooth module and integrating circuitry in a new and innovative manner, consumers can control the functionality of a remote control simply by playing audio files.

### DESCRIPTION OF THE PREFERRED EMBODIMENT

Reference will now be made in detail to an embodiment, an example of which is illustrated in the accompanying drawings. In the following detailed description, details are set forth in order to provide a thorough understanding of the present invention. However, it will be apparent to one of ordinary skill in the art that the present invention may be practiced without these specific details. In other instance, well-known methods, procedures, components, and circuits have not been described in detail so as not to unnecessarily obscure aspects of the embodiment.

The terminology used in the description of the invention herein is for the purpose of describing a particular embodiment only and is not intended to be limiting of the invention. As used in the description of the invention and the appended claims, the singular forms “a”, “an” and “the” are intended to include the plurals forms as well, unless the context clearly indicates otherwise. It will be also understood that the terms “comprise” and/or “comprising” when used in this specification, specify the presence of stated features, elements, and/or components, but do not preclude the presence or addition of one or more features, elements, components, and/or groups thereof.

Embodiment of a Smart Switch is described. An Infrared Remote Control comprising of a plastic housing, 31 buttons, a Power Source, a Power Control Board, an Integrated circuit, an Infrared Light Emitting Diode, and a Bluetooth Module. When a button is pushed, the Integrated Circuit causes the IR LED to emit modulated (pulsed) infrared light.

Each button has a defined audio pattern associated with it. Thus, 31 different audio formats are required. Using an audio length of 50 ms, divided into 5 ms, this results in 10 consecutive blasts of audio. Using silence as a 0 bit, and 15 khz of sound as a 1 bit, there are 100 (10̂2) possible combinations of sound. Using the first 31, we have 31 uniquely formatted audio streams that are paired with each button.

When the Bluetooth module inside the Smart Remote receives any one of these 31 streams, a signal is sent to the integrated circuit that mimics the signal sent when the manual button is pushed. Then, the appropriate modulation is emitted from the IR LED. Thus, the invention allows for remote control from a “paired” Bluetooth enabled Smart Phone or similarly capable device.

The foregoing description, for purpose of explanation, has been described with reference to a specific embodiment. However, the illustrative discussions above are not intended to be exhaustive or to limit the invention to the precise forms disclosed. Many modifications and variations are possible in view of the above teachings. The embodiment was chosen and described in order to best explain the principles of the invention and its practical applications, to thereby enable others skilled in the art to best utilize the invention and various embodiments with various modifications as are suited to the particular use contemplated.

### BRIEF DESCRIPTION OF THE DRAWINGS

For a better understanding of the aforementioned embodiments of the invention as well as additional embodiments thereof, reference should be made to the Description of the Preferred Embodiment above, in conjunction with the following drawings in which like reference numerals refer to corresponding parts throughout the figures.

FIG. 1A is a sample audio format that would be received by the Bluetooth module on the Smart Remote such that it triggers the integrated circuit in the same manner as when a manual button on the remote has been pressed. It represents the frequency and duration of the formatted audio.

FIG. 2A is a block diagram illustrating a Smart Remote in accordance with some embodiments.

FIG. 3A illustrates a physical representation of a possible embodiment.

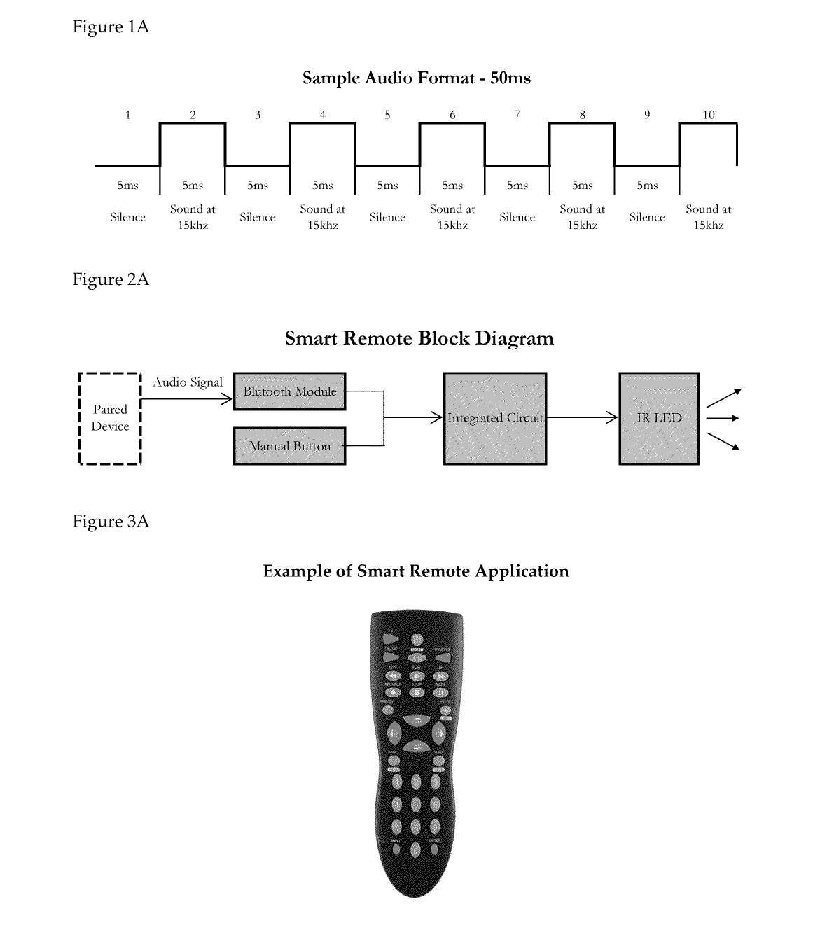

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING

Not applicable.

What is claimed is:

1. A remote control whose button functionality can be controlled when a specifically formatted audio stream is played by a paired Bluetooth device and received by the remote control.
